(19) United States
(12) Patent Application Publication
(10) Pub. No.: US 2002/0071637 A1
(43) Pub. Date: Jun. 13, 2002

(54) Packaging for fiber optic device

(75) Inventors: Michael A. Centanni, Parma, OH (US); Mark Kusner, Gates Mills, OH (US)

Correspondence Address: Mark Kusner, Highland Place, Suite 310, 6151 Wilson Mills Road, Highland Heights, OH, 44143, US

(73) Assignee: GA-TEK Inc. (dba Gould Electronics Inc.)

(21) Appl. No.: 09/734,260

(22) Filed: Dec. 11, 2000

(51) Int. Cl. G02B 6/36

(52) U.S. Cl. 385/51; 385/99

(57) ABSTRACT

A package for a fiber optic device or fiber optic component having at least one optical fiber extending therefrom. The package is comprised of a support substrate for supporting the optical device or optic component, the support substrate having at least one optical fiber extending therefrom. A housing surrounds the substrate and has an opening at one end. At least one optical fiber extends through the opening. A layer of metal seals the opening of each end of the tube and the glass fiber cladding where the optical fiber extends through the layer of metal.

### FIELD OF THE INVENTION

The present invention relates to packaging for fiber optic devices and optic components such as couplers, splitters, sensors and the like, and more particularly to a fiber optic package that hermetically seals the optical device or optic component from external environmental conditions.

### BACKGROUND OF THE INVENTION

The widespread and global deployment of fiber optic networks and systems mandates that fiber optic equipment and components operate reliably over long periods of time. This mandate imposes stringent performance requirements on various fiber optic components that are used in such networks and systems. In this respect, since fiber optic components are expected to operate reliably in hostile environments, prior to qualification for use, such components are typically subjected to an array of mechanical and environmental tests that are designed to measure their performance. One of these tests is a damp/heat soak test, wherein a fiber optic component is exposed to elevated temperature and humidity conditions (typically 85° C. and 85% relative humidity) for an extended period of time. Fiber optic couplers exposed to such conditions exhibit a gradual drift in insertion loss. Eventually this drift will cause a coupler to fail to meet its assigned performance specifications.

It is believed that the primary cause for failure is water vapor or some component, constituent or by-product of water vapor diffusing into the exposed core glass of the coupler and changing its index of refraction. In an attempt to prevent migration of moisture into the coupling region, it has been known to package fiber optic couplers and other optic components inside metal tubing and to seal the ends of the tubing with a polymeric material, such as a silicon-based material or epoxy. These types of materials have not proved successful in preventing the aforementioned problem.

The present invention overcomes these and other problems and provides a packaging for a fiber optic component, wherein the optic component is totally enclosed within a glass structure.

### SUMMARY OF THE INVENTION

In accordance with the present invention, there is provided a package for a fiber optic coupler having at least one optical fiber extending therefrom. The package is comprised of a support substrate for supporting the fiber optic coupler with at least one optical fiber extending therefrom. The optical fiber has an inner glass fiber cladding surrounded by an outer jacket. A tube surrounds the substrate, and the at least one optical fiber extends from one end of the tube. A material encloses each end of the tube. The material engages the optical fiber where the optical fiber extends through the material. A deposited metal covers at least a portion of each end of the tube, the optical fiber, the metal and the material sealing each end of the tube where the optical fiber extends through the material.

In accordance with another aspect of the present invention, there is provided a package for a fiber optic device or fiber optic component having at least one optical fiber extending therefrom. The package is comprised of a support substrate for supporting the optical device or optic component, the support substrate having at least one optical fiber extending therefrom. A tube surrounds the substrate and has an opening at each end. At least one optical fiber extends from one end of the tube through the opening. A layer of metal seals the opening of each end of the tube and the optical fiber where the optical fiber extends through the layer of metal.

In accordance with another aspect of the present invention, there is provided a packaged, optical device comprised of an optical device having at least one optical fiber extending therefrom. A structurally rigid housing encases the optical device. The housing has an internal cavity for containing the optical device and at least one opening that communicates with the cavity. The optical fiber extends through the opening. A continuous, arc sprayed barrier layer is provided on the housing at least in the vicinity of the opening, the barrier layer covering the housing in the vicinity of the opening and a portion of the optical fiber extending through the opening. The barrier layer covers the opening to seal the optical device within the housing.

In accordance with another aspect of the present invention, there is provided a method of packaging a fiber optic device having at least one optical fiber extending therefrom, comprising the steps of:

a) mounting a fiber optic device having at least one optical fiber extending therefrom onto a substrate;

b) enclosing the fiber optic device within a cavity in a structure having at least one opening therein, through which the at least one optical fiber extends; and

c) forming a generally continuous moisture impervious layer over the opening and the optical fiber, wherein the moisture impervious layer closes the opening in the structure and seals the cavity.

It is an object of the present invention to provide packaging for a fiber optic component or a fiber optic device.

It is an object of the present invention to provide packaging as described above for a fiber optic component or a fiber optic device including generally continuous optical fibers.

It is another object of the present invention to provide packaging for a fiber optic coupler.

Another object of the present invention is to provide packaging as described above that hermetically seals the fiber optic component or fiber optic device from the surrounding environment.

Another object of the present invention is to provide packaging as described above that does not require the use of precision components to achieve hermetic sealing of the optical fibers.

A still further object of the present invention is to provide packaging as described above that retards or prevents slow drift in insertion loss in couplers due to damp/heat environments.

These and other objects will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a sectioned, top plan view of a packaged fiber optic device, illustrating a preferred embodiment of the present invention;

FIG. 2 is a sectional view taken along lines 2-2 of FIG. 1;

FIG. 3 is a sectional view taken along lines 3-3 of FIG. 2;

FIG. 4 is an enlarged, top plan view of one end of a housing in the fiber optic device shown in FIG. 1;

FIG. 5 is a sectional view taken along lines 5-5 of FIG. 4;

FIG. 6 is a partially sectioned, perspective view of a housing from the packaged fiber optic device shown in FIG. 1, showing the housing with an outer sleeve that is displaced axially therefrom;

FIGS. 7-10 are perspective views of one end of a housing for a fiber optic device, illustrating the steps of a preferred method for sealing around the optic fibers extending through an opening in the housing;

FIG. 11 is a top plan, sectioned view of one end of the device shown in FIG. 1, schematically illustrating a preferred method of forming a moisture barrier at the end of a housing in the device;

FIG. 12 is a top plan, sectioned view of one end of the device shown in FIG. 1, schematically illustrating another method of forming a barrier at the end of a housing in the device;

FIG. 13 is a top plan, sectioned view of one end of a packaged fiber optic device, illustrating another embodiment of the present invention;

FIG. 14 is an enlarged, side elevational, sectioned view of one end of a packaged fiber optic device, schematically illustrating another embodiment of the present invention;

FIG. 15 is an enlarged, side elevational, sectioned view of one end of a housing for a fiber optic device, illustrating yet another embodiment of the present invention;

FIG. 16 is a sectional view taken along lines 16-16 of FIG. 15; and

FIG. 17 is an enlarged, side elevational, sectioned view of one end of a housing for a fiber optic device, illustrating still another embodiment of the present invention, wherein an opening at the end of the housing is sealed completely with metal.

### DETAILED DESCRIPTION OF PREFERRED EMBODIMENT

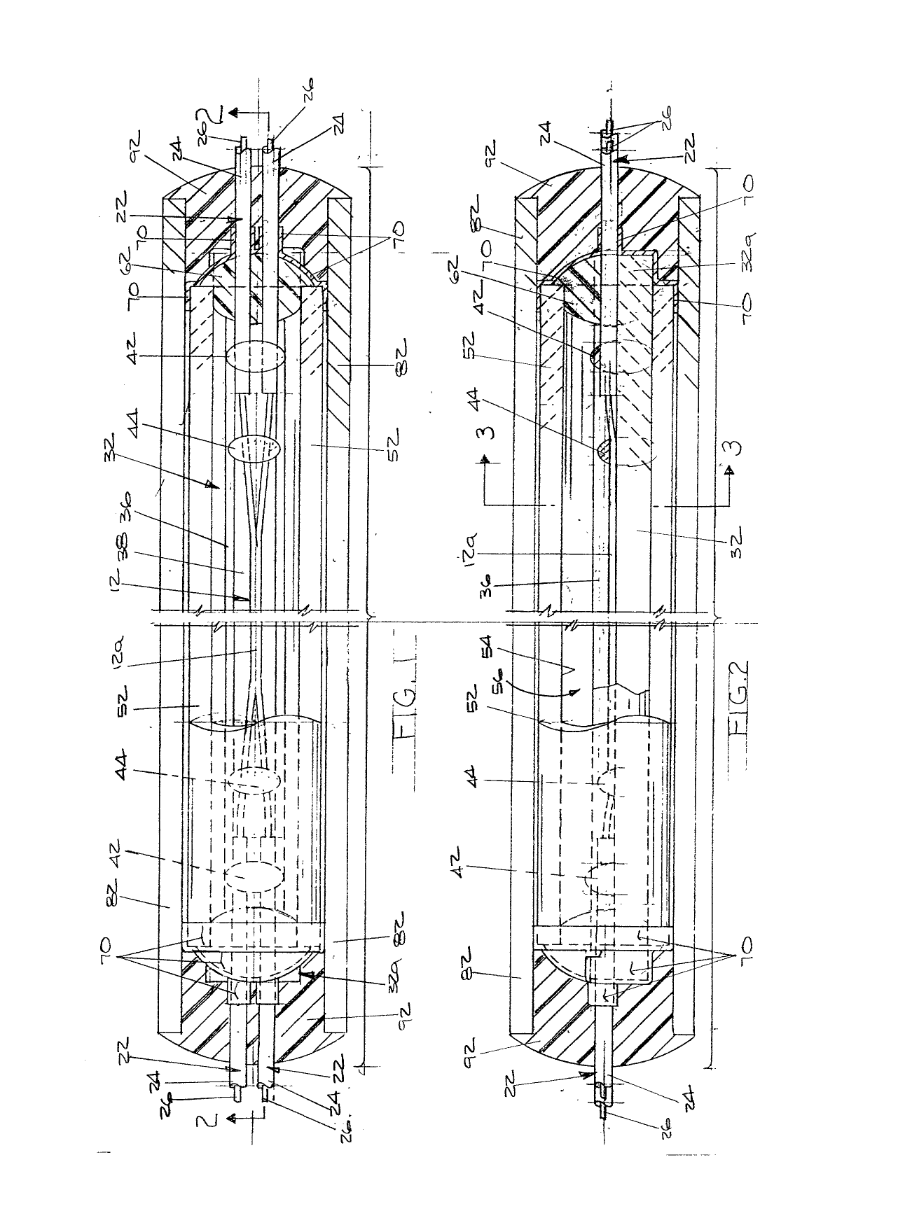

Referring now to the drawings wherein the showings are for the purpose of illustrating the preferred embodiment of the invention only, and not for the purpose of limiting same, FIGS. 1 and 2 show a package 10 for enclosing a fiber optic device. (In the drawings, the respective parts in many instances are not drawn to scale, and in some instances are exaggerated for the purpose of illustration). In the embodiment shown, package 10 encloses a 2×2 fiber optic coupler 12. It will, of course, be appreciated that other types of fiber optic components or fiber optic devices may be enclosed within package 10, in accordance with the present invention. In the art, the term “optic device” generally refers to active elements or apparatus; whereas, the term “optic component” generally refers to elements or apparatus that are passive. The present invention is applicable to both fiber optic devices and fiber optic components. Accordingly, as used herein, the term “optic device(s)” shall refer both to optic devices and optic components.

Coupler 12 is formed from two or more continuous optical fibers, designated 22, that have been coupled by a conventionally known method. Coupler 12 in and of itself forms no part of the present invention. Coupler 12 has a coupling region, designated 12a. Each fiber has an outer jacket or buffer 24 comprised of a polymeric material that surrounds inner glass fiber cladding 26. As is conventionally understood, jackets or buffers 24 of fibers 22 are removed along a portion of their length to facilitate the manufacturing of a coupler.

Coupler 12 is supported on a substrate 32. In the embodiment shown, substrate 32 is a cylindrical rod having a longitudinally extending groove 34 formed therein. Groove 34 is generally defined by a pair of planar, sloping side surfaces 36 and a planar bottom surface 38, best seen in FIG. 4. Substrate 32 is provided to support coupler 12. In the embodiment shown, coupler 12 is mounted to substrate 32 by a small amount of epoxy 42 disposed on opposite sides of coupling region 12a. The primary purpose of epoxy 42 is to hold coupler 12 in place upon substrate 32 until coupler 12 is subsequently secured to substrate 32 by a glass-based bonding composition 44. Composition 44 is comprised essentially of glass powder and a volatile solvent in a slurry form. The slurry is allowed to dry by allowing the volatile solvent to evaporate, resulting in a generally solid mass that is softened, preferably by a laser, to bond glass fibers 26 of optical fibers 22 to substrate 32. In this respect, bonding composition 44 and substrate 32 are preferably formed of glass having similar physical properties, e.g., coefficient of thermal expansion, as the glass forming the cladding of fibers 22. A suitable glass-based bonding composition is disclosed in prior U.S. Pat. Nos. 5,500,917 and 5,682,453, both to Daniel et al., the disclosures of which are expressly incorporated herein by reference.

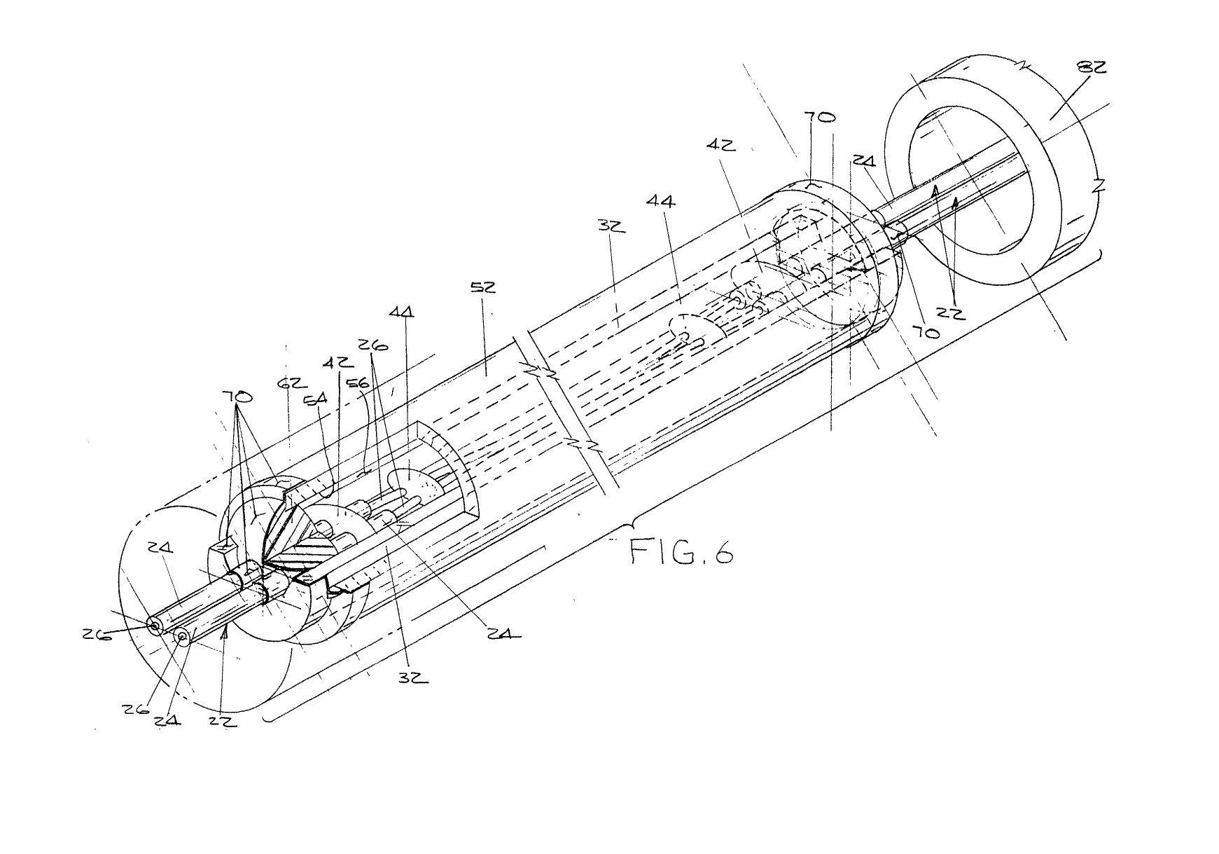

With coupler 12 mounted to substrate 32, a tube 52 is positioned around substrate 32. In the embodiment shown, tube 52 is cylindrical in shape, and has an inner cylindrical surface 54 defining a cylindrical inner bore or opening. The inner bore is dimensioned to be slightly larger than the diameter of substrate 32, so that glass tube 52 receives substrate 32 in close mating fashion, as best illustrated in FIG. 6. Tube 52 is preferably formed of glass composition similar to that of substrate 32. Tube 52 is preferably shorter than substrate 32, such that end portions 32a of substrate 32 extend beyond each end of tube 52, as best seen in FIGS. 6-10. Each end portion 32a defines a ledge or shelf that supports optical fibers 22 as they extend from tube 52. Between substrate 32 and inner surface 54 of tube 52, an elongated cavity or passage 56 is defined through tube 52. A seam 58 is defined between the bottom of substrate 32 and tube 52.

In the context of the present invention, tube 52 is essentially a rigid, structural housing provided to contain and protect coupler 12 and more particularly, to surround and protect coupling region 12a. Tube 52 has an interior cavity that provides space around coupling region 12a for the operation thereof. Although a cylindrical tube 52 is illustrated in the drawings, other types of housing structures may be used to contain coupler 12. Such housing need only have the structural integrity required to protect coupler 12, and have at least one opening to allow optic fibers 22 to exit the housing. As will be appreciated by those skilled in the art, from a further reading of the specification, the housing containing coupler 12 need not be tubular, and need not be a single piece structure. In this respect, multi-piece structures may be used to form the housing enclosing and surrounding coupler 12. Further, substrate 32 may even constitute part of a housing assembly, such as when used in combination with a cover plate covering substrate 32.

Further, while tube 52 is described as being formed of glass, tube 52 or any housing structure, may also be formed of quartz, metal or plastic. Since an object of the present invention is to try to hermetically seal an optic device or optical component from external environmental conditions, glass, quartz and metal that have good characteristics with respect to moisture penetration are preferred materials. However, relatively porous materials, such as plastic, may find advantageous application in forming a housing structure, i.e., tube 52, as shall be described in greater detail below.

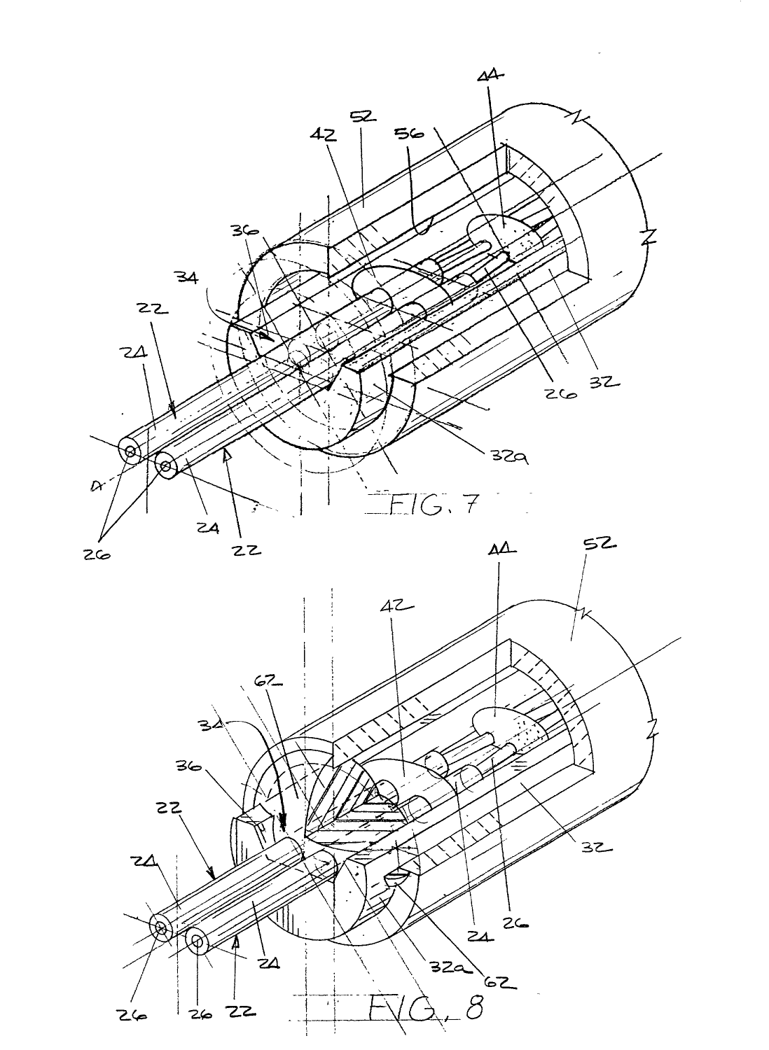

Referring now to FIGS. 7-10, a preferred method of closing and sealing the ends of tube 52 is illustrated. FIG. 7 is a perspective view of one end tube 52, showing portion 32a of substrate 32 extending from the end of tube 52 and supporting optical fiber 22 in groove 34 in substrate 32. With substrate 32 within glass tube 52, the ends of glass tube 52 are preferably plugged with a mass 62 of an adhesive/sealant material. As shown in FIG. 8, mass 62 may be applied into groove 34 on end portion 32a. Groove 34 on portion 32a forms a receptacle to receive mass 62 that may be in an uncured, viscous state. In this respect, as will be appreciated by those skilled in the art, fibers 22, substrate 32 and glass tube 52 are extremely small. For example, the diameter of each optical fiber 22 may be about 250 μm and the diameter of substrate 32, which is essentially a cylindrical rod having a groove formed therein is about 0.07 inches (0.1778 cm). Glass tube 52 would preferably have an inner diameter only slightly larger than the diameter of substrate 32 and an outer diameter to produce a tube wall thickness of about 0.03 inches (0.079 cm).

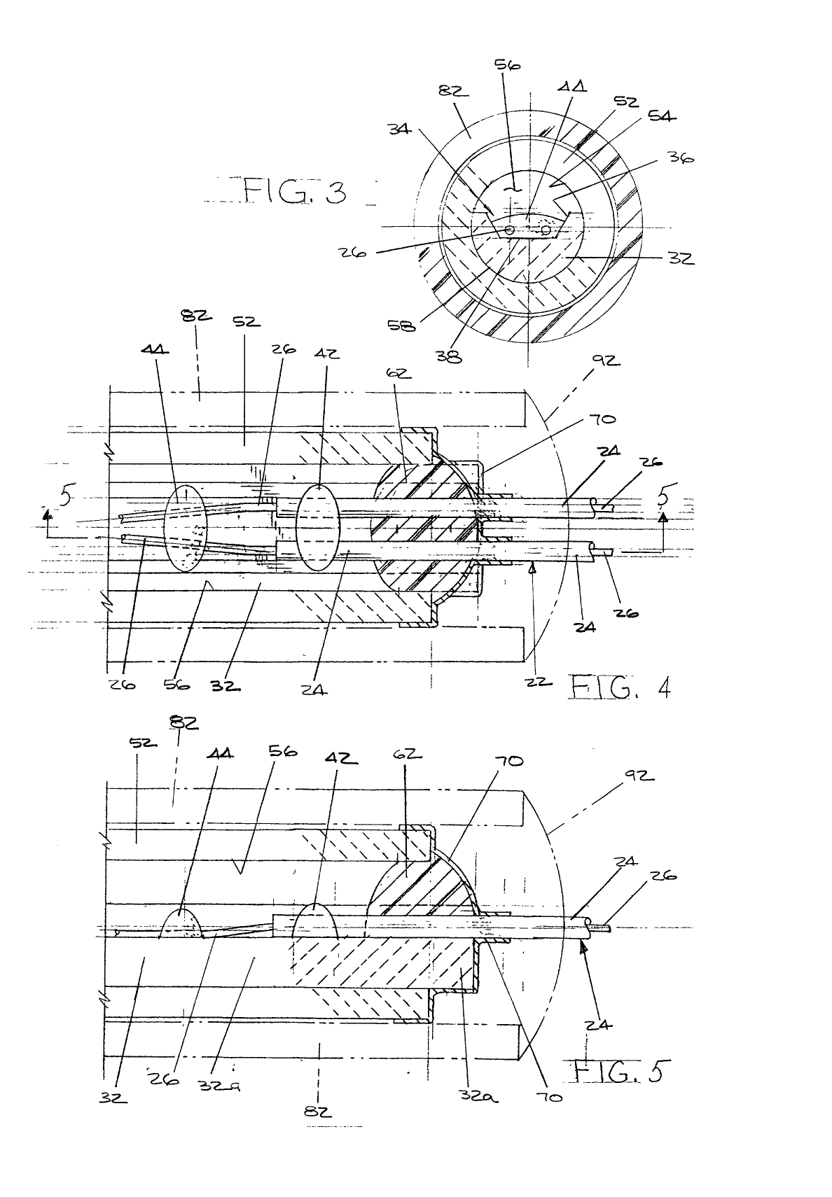

At these sizes, it is difficult to physically insert an adhesive/sealant material into the interior of tube 52 past substrate 32 and optical fibers 22. By providing extension portion 32a, groove 34 in substrate 32 provides a convenient receptacle to receive the adhesive/sealant material, wherein the ends of tube 52 and the surface of substrate 32 provide sufficient surface area for even small droplets of material to wet and form a bead around optical fibers 22 and the end surface of tube 32. In one respect, mass 62 is provided to secure substrate 32 to tube 52 to prevent relative displacement of these components during subsequent processing. In another respect, mass 62 plugs and closes the ends of glass tube 52, thereby forming a first protective barrier between coupling region 12a and the external environment. Mass 62 defines an outer surface 62a at the end of tube 52. As will be appreciated from a further reading of this specification, mass 62 is preferably formed of a material with good adhesive properties to both glass and metal. A thermoplastic or thermosetting polymeric material may be used to form mass 62. Thermosetting polymer materials such as epoxy resins or urethanes may be used. Mass 62 is preferably formed of a thermoplastic having a softening temperature of between 100° C. and 370° C. Preferred materials for forming mass 62 are polyimide and acrylic polymers. As illustrated in FIG. 8, optical fibers 22 extend through mass 62. In the embodiment shown in FIGS. 1-12, where optical fibers 22 extend through mass 62, the outer jacket or buffer 24 remains around inner glass fiber claddings 26.

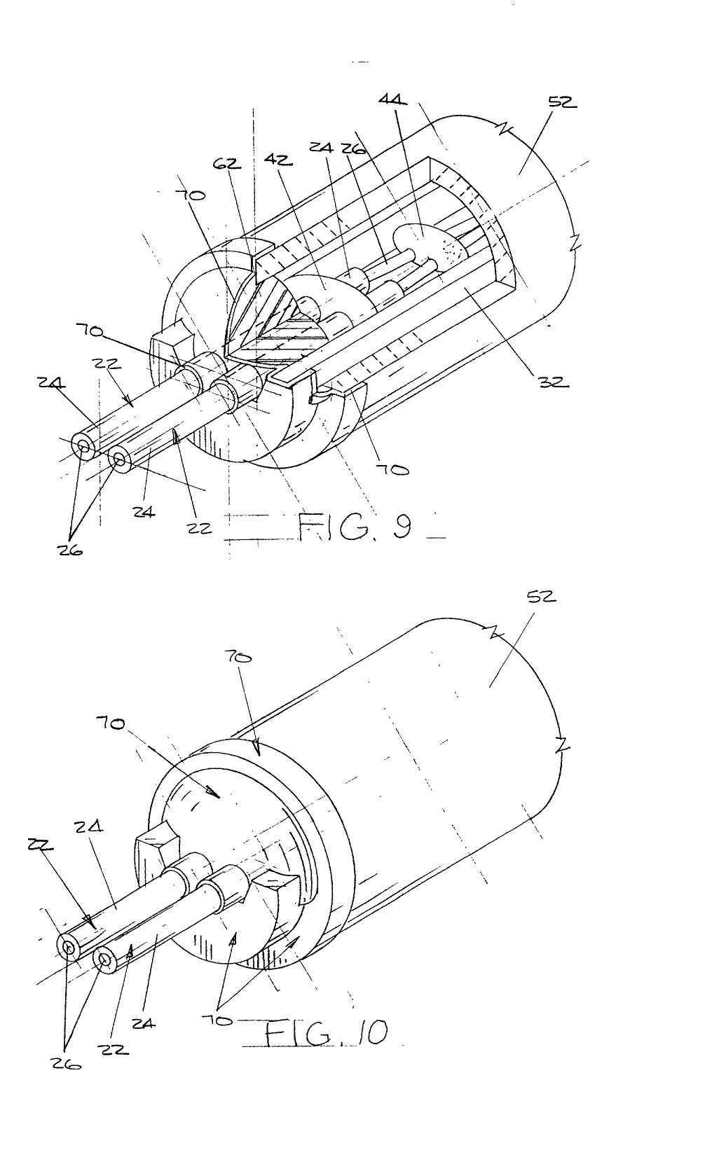

Referring now to FIG. 9, with substrate 32 disposed within tube 52, and with each end of tube 52 plugged by mass 62, a moisture barrier layer 70 is applied to the end portions of tube 52, end portions 32a of substrate 32, surfaces 62a and optical fibers 22. As used herein, the term “moisture barrier” refers to any material that significantly prevents or retards moisture penetration. Barrier layer 70 may be formed of a ceramic or glass material, but in a preferred embodiment, barrier layer 70 is formed of a metal. It is believed that compositions of these types of material, and particularly the crystalline structure of a metal barrier layer 70, if disposed on surfaces 62a of mass 62 and the ends of tube 52 and substrate 32, would provide a moisture barrier that would effectively seal the interior of tube 52 from external environmental conditions.

At a lower limit, the thickness of barrier layer 70 is the minimum thickness necessary to form a continuous, non-pervious layer over surface 62a of mass 62, the ends of glass tube 52 and substrate 32 and the surface of optical fibers 22 extending through mass 62. A metal barrier layer 70, in one embodiment, has a thickness of at least about 10 Å. In another embodiment, metal layer 70 has a thickness of between 100 Å and 250 μm, and yet another embodiment, between 250 Å and 25 μm.

A metal barrier layer 70 may be formed from any metal, but is preferably formed of metal having good adhesive properties to glass tube 52 and to the material forming mass 62. Barrier layer 70 is preferably formed of one of the following metals: aluminum, zinc, copper, nickel, tin, tin/lead, tin/zinc, aluminum bronze, phosphor bronze, steel, stainless steel, monel or gold. In one embodiment, barrier layer 70 is formed of zinc.

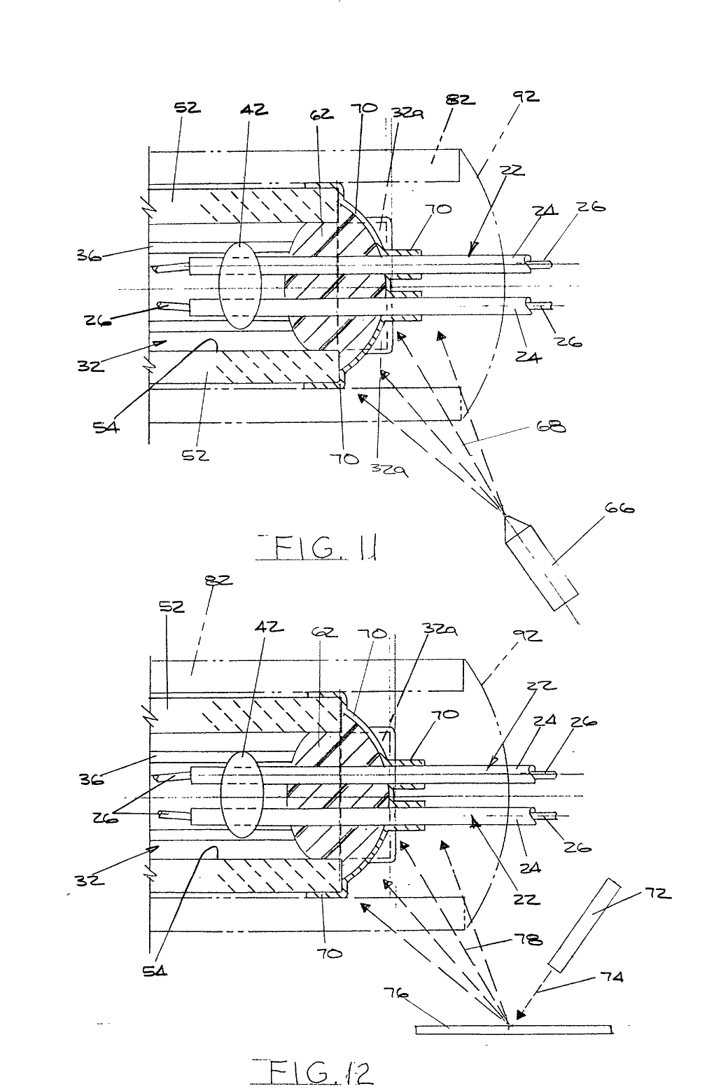

Barrier layer 70 is preferably applied by a thermal spraying process, as schematically illustrated in FIG. 11, that shows a spray nozzle 66 directing a spray 68 of liquid metal onto the end of glass tube 62, surface 62a of barrier mass 62 and the ends of fiber jackets 24. A thermal spraying process can be categorized into two groups. Lower energy processes are electric arc spraying and flame spraying. Higher energy processes include plasma arc spraying and high velocity oxygen fuel spraying. In a conventional arc-spraying process, a metal to be sprayed is heated to its liquid molten state by an electric arc. Then, an air blast breaks down the molten metal into fine droplets that cool and solidify when they strike the surface to be sprayed. The metals identified above are capable of electric arc spraying. Plasma arc spraying uses the heat generated from a non transferred plasma arc to melt powder or wire feedstock. A main advantage of plasma arc spraying is that metals and ceramics can be sprayed. Either process may be used if barrier layer 70 is formed of metal. A plasma arc spraying process is preferably used if barrier layer 70 is formed of a glass or ceramic.

Preferably, an electric arc spraying process is used to apply a metal barrier layer 70. Of the metals disclosed above, zinc, aluminum, tin, lead and alloys thereof are more preferably used to form a metal barrier layer 70 because of their relatively lower melting points compared to the other identified metals. In this respect, the outer jacket or buffer 24 on an optical fiber 22 is typically formed of an acrylic material having a softening temperature of about 205° C. (about 400° F.). Since the arc spraying process sprays molten metal in the form of fine droplets, preferably the metal used has a relatively low melting point to prevent, or reduce, thermal degradation of fiber jacket 24 and adhesive material forming mass 62 during formation of barrier layer 70.

In the drawing, barrier layer 70 is shown with distinct, well-defined edges. As will be appreciated by those skilled in the art, compared to the size of components heretofore described, electric arc spraying is a gross process (“gross” meaning not fine, precise or delicate). Accordingly, a barrier layer 70 applied by an electric arc-spraying technique will not produce the well-defined, exact boundaries shown in the drawings. Rather, a feathered edge and significant overspray of tube 32 and fibers 22 is expected. If tube 32 is glass or metal, it is important to form a continuous barrier layer 70 over the end of tube 32 and fibers 22 extending therefrom, although metal could optionally be sprayed over the entire tubular surface. As indicated above, a housing, such as tube 32, may also be formed of a plastic material. Because of its porous, amorphous structure, if plastic is used to form a housing containing coupler 12, metal barrier layer 70 is applied on the entire outer surface of the plastic housing, along with the opened end(s) of the structure, to form a metal seal layer over the entire housing. Thus, the plastic provides the structural rigidity and the barrier layer 70 applied thereover provides the moisture resistance.

To reduce the likelihood of thermal degradation of a plastic housing or fiber jacket 24 and the adhesive material forming mass 62, an alternate method of applying a metal barrier layer 70 is schematically illustrated in FIG. 12. In the embodiment shown in FIG. 12, a metal barrier layer 70 is applied by a vacuum metallization process, such as thermal evaporation, sputtering or e-beam deposition. Metal layer 70 is preferably applied by sputtering. As schematically illustrated in FIG. 12, an electron beam gun 72, directs a stream of electrons 74 at a target 76 that is comprised of the metal to be deposited. Metal atoms and agglomerates, designated 78, that are liberated by electron beam 74, are deposited onto the ends of tube 52, surface 62a and the ends of fiber jackets 24 that extend from mass 62.

With the ends of glass tube 52 and substrate 32 coated with barrier layer 70, an outer metallic sleeve 82 is positioned to encase glass tube 52, as illustrated in FIGS. 1 and 2. In the embodiment shown, outer sleeve 82 is cylindrical in shape and has an inner diameter closely matching the outer diameter of glass tube 52, but leaving sufficient space to accommodate barrier layer 70. Outer sleeve 82 is preferably formed of a metal or rigid plastic to provide additional protection to glass tube 52 containing coupler 12.

In a preferred embodiment of the present invention, outer sleeve 82 is preferably formed of INVAR, a registered trademark of Imphy S.A. Corporation for an alloy comprised of nickel and steel. As best seen in FIGS. 1 and 2, outer sleeve 82 is longer than glass tube 52 and substrate 32. Outer sleeve 82 preferably has a length such that the ends of outer sleeve 82 will surround and enclose at least a portion of the ends of substrate 32. The ends of outer sleeve 82 are filled with an adhesive/sealant 92, such as a silicon-based material manufactured by Dow Corning® under the trade designation 3145 Mil-A-46146. Adhesive/sealant 92 fills the space defined by outer sleeve 82 and captures fibers 22. Adhesive/sealant 92 thereby provides additional support for optical fibers 22 so as to relieve any strain on optical fibers 22 that would exist in the absence of adhesive/sealant 92.

The present invention thus provides a package for a fiber optic device that hermetically seals coupling region 12a from external environmental conditions. Since a continuous layer of metal exists over the ends of glass tube 52 and substrate 32, mass 62 and fibers 22 that extend through mass 62, the likelihood of water vapor or some component, constituent or by-product of water vapor penetrating into the interior of tube 52 and the area surrounding coupling region 12a is significantly reduced, if not prevented. It will be appreciated by those skilled in the art that a moisture barrier results from the continuous layer of metal that exists over the end of glass tube 52, mass 62 and over outer jackets or buffers 24 of optical fibers 22.

In the embodiment shown in FIGS. 1-12, barrier layer 70 coats jacket or buffer 24 of optical fiber 22. It is understood that a possible avenue for moisture (i.e., water vapor, or a component, constituent or by-produce thereof) to diffuse into the interior of sleeve 32 is through jacket or buffer 24 of optical fiber 22. Since, as noted above, buffer 24 is typically an acrylic material which is amorphous, it is possible that moisture from the environment outside package 10 could penetrate buffer 24 and then diffuse axially through buffer 24 into the interior of sleeve 32. It is believed, however, that such penetration and diffusion of moisture (water vapor, or a component, constituent or by-product thereof) through buffer 24 along the axis of fibers 22 would be small, and that package 10 would provide acceptable performance in the damp/heat soak test described above.

While FIGS. 1-12 show an embodiment that has barrier layer 70 applied to the buffers 24 of optical fiber 22, the present invention also applies to forming a barrier layer 70 on an optical fiber 22 where buffer 24 has been removed. FIGS. 13-17 show alternate embodiments, wherein a barrier layer is formed on the fiber cladding 26 of optical fibers 22.

Referring now to FIG. 13, a package 110 illustrating an alternate embodiment of the present invention is shown. As in the embodiment previously described in FIGS. 1-11, package 110 includes a coupler 12 (not seen in FIG. 13) supported on a substrate 32 in the same manner as heretofore described. (In the embodiments shown in FIGS. 13-17, components that are similar to those previously described have been designated by like reference numbers.) Instead of placing substrate 32 within a glass tube 52 as previously described, substrate 32 with coupler 12 thereon is placed within a larger metallic sleeve, designated 182. Sleeve 182 is preferably formed of a metal or plastic, similar to sleeve 82 previously described, to provide protection to substrate 32. In this respect, sleeve 182 constitutes the structural housing for coupler 12. In a preferred embodiment of the present invention, sleeve 182 is preferably formed of INVAR®. As shown in FIG. 13, sleeve 182 is longer than substrate 32. Sleeve 182 preferably has a length such that the ends of sleeve 182 will surround and enclose fibers 22 extending from substrate 32. The outer ends of sleeve 182 are filled with mass 162 of a material similar to mass 62, as heretofore described, to plug the ends of sleeve 182. As shown in FIG. 13, where optical fibers 22 extend through mass 162, the outer jacket or buffer 24 of optical fibers 22 that surround inner glass fiber claddings 26 is removed. Mass 162 defines an outer surface 162a.

With each end of outer sleeve 182 sealed by mass 162, at least the end portion of outer sleeve 182, surface 162a and optical fibers 22 are coated with a barrier layer 170. As described above, barrier layer 170 may be a glass, ceramic or metal. In a preferred embodiment, barrier layer 170 is a metal that is preferably applied by thermal spraying in a manner as described. Barrier layer 170 has a thickness and metal composition as previously described. After applying metal barrier layer 170 to at least the interior of sleeve 182, surface 162a and the exposed portions of glass fiber claddings 26, the ends of sleeve 182 are filled with an adhesive sealant 192. Sealant 192 preferably extends around and captures each end of outer sleeve 182 and further captures a portion or jacket of buffer 24 of optical fibers 22. Adhesive/sealant 192 provides support for optical fibers 22 so as to relieve strain on cladding 24 of optical fibers 22 that would exist in the absence of adhesive/sealant 192. Adhesive/sealant 192 is preferably formed of a silicon-based material such as that heretofore described as being manufactured by Dow Coming® under the trade designation 3145 Mil-A46146. The removal of buffers 24, and the continuous, circumferential portion of barrier layer 170 that encases claddings 26, block any water vapor from diffusing into the interior of sleeve 182.

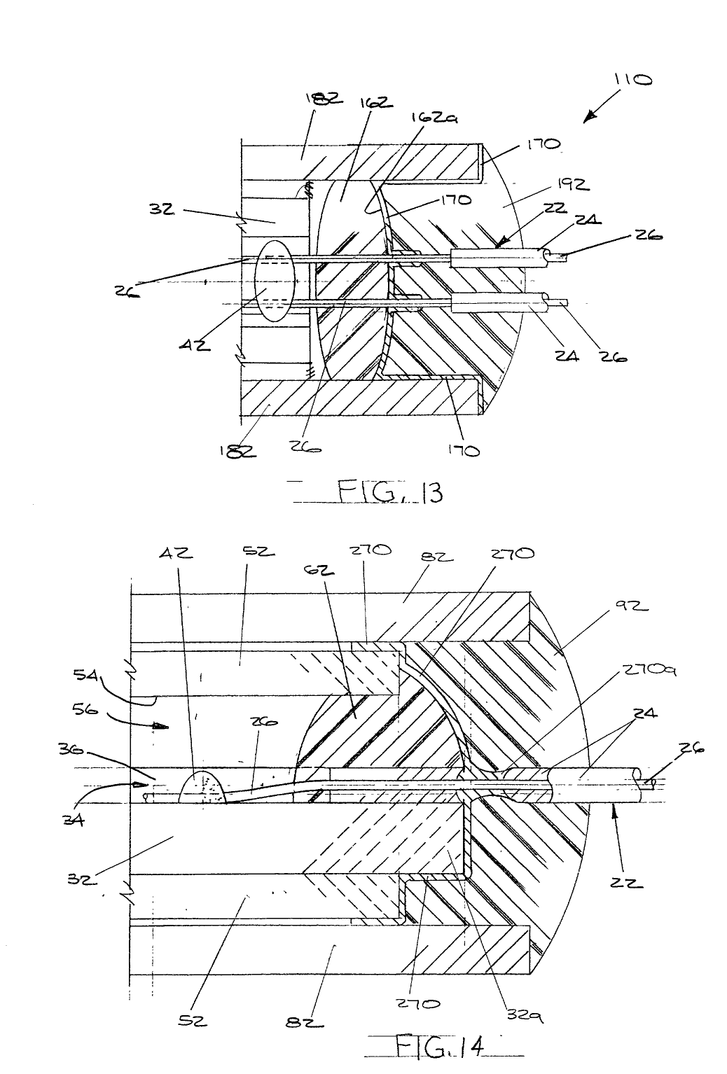

Referring now to FIG. 14, another embodiment of the invention is shown. FIG. 14 shows an enlarged end of a package 210 as heretofore described with respect to FIGS. 1-12. Package 210 includes optical fibers 22 mounted to a substrate 32, as previously described. Substrate 32 is disposed within a tube 52. A mass 62 plugs the end of tube 52 and secures fibers 22 to substrate 32. A barrier layer 270, preferably of metal and preferably electric arc-sprayed, is formed over the end of tube 52, mass 62 and optical fibers 22. Barrier layer 270 includes a collar portion 270a that surrounds and engages fiber cladding 26 of optical fiber 22 in the vicinity where optical fiber 22 extends through mass 62. In the embodiment shown, collar 270a is formed by utilizing a barrier material having a melting point (in the case of metals) or a softening point (in the case of glass or ceramic) that is much higher than the softening point of the acrylic-forming jacket 24 of optical fiber 22. Where the arc-sprayed barrier material engages optical fiber 22, the high melting or softening point of the barrier material degrades the acrylic buffer 24, allowing the barrier material to form collar 270a around fiber cladding 26. The higher melting temperature or softening temperature of the barrier material will not significantly affect a substrate 32 or a tube 52 that in the embodiment shown is formed of glass, as illustrated in FIG. 14. The higher temperature of the barrier material may degrade mass 62 (not shown), but because of the significantly greater amount of mass 62, this degradation may not affect material forming mass 62 to a great extent. An outer sleeve 82 surrounds tube 52 and an adhesive/sealant material 92 of the type heretofore described fills the end of sleeve 82 to provide strain relief to optical fiber 22. Collar 270a of barrier 270 prevents any migration of moisture into cladding 22.

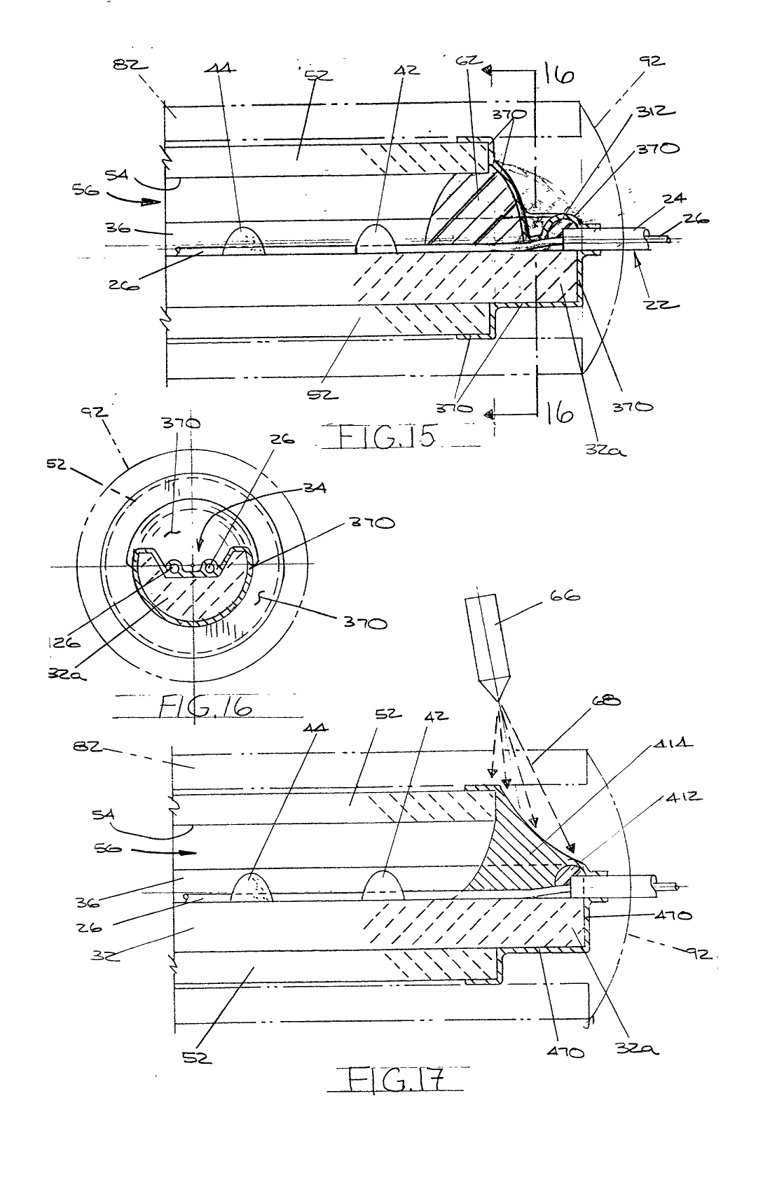

Referring now to FIG. 15, another embodiment of the present invention is shown. FIG. 15 essentially shows a package 10 as described in FIGS. 1-12, wherein buffer or jacket 24 of optical fiber 22 is removed to almost the end of substrate 32. A small bead 312 of epoxy captures the end of jacket 24 to secure the optical fiber 22 to substrate 32. A mass of a sealant/adhesive material 62 is applied to plug tube 32. As illustrated in FIG. 15, a small section of cladding 26 of optical fibers 22 is left exposed between the bead of adhesive and mass 62. A barrier layer 370, preferably metal and preferably applied by a electric arc-spraying process, is applied over the end of tube 52, mass 62 and optical fiber 22. The arc-sprayed metal layer 370 basically coats around the optical claddings 24 of optical fibers 22, as best seen in FIG. 16. Metal barrier layer 370 surrounding optical cladding 26 of fibers 22 prevents any moisture from migrating down buffer or jackets 24 into the interior of tube 52. As shown in phantom in FIG. 15, an outer sleeve 82 is preferably provided and a sealant/adhesive material 92 fills the end of sleeve 82 to capture fibers 22 and provide strain relief therefor, as was heretofore described.

In the embodiments heretofore described, a mass 62 of an adhesive/sealant material is used to plug the openings or ends of housings, i.e., tubes 52, prior to application of a barrier layer 70, 170, 270, 370. FIG. 17 shows an alternate embodiment, wherein the opening between a substrate 32 and a glass tube 52 is sealed without the use of a barrier mass 62. In FIG. 17, the buffer or jacket on the optical fibers 22 forming coupler 12 are removed to almost the end of substrate 32, leaving only a small section of jacket 24 to be adhered to substrate 32 by a bead of epoxy 412. Using preferably a metal and an arc-spraying process, the entire opening between the surface of substrate 32 and tube 52 is preferably filled solely with metal from the arc-spraying process to form a metal seal 414 closing the ends of tube 52 around fiber cladding 26 of optical fibers 22. As seen in FIG. 17, metal seal 414 basically fills groove 34 in substrate 32 and forms a continuous metal wall or shield enclosing the end of tube 52. Metal seal 414 encasing the fiber cladding 26 of optical fibers 22 prevents migration of moisture into glass tube 52. Although the embodiment shown in FIG. 17 shows arc-sprayed metal covering optical cladding 26 of optical fiber 22, it will be appreciated that this concept of sealing tube 52 by merely applying a metal layer onto optical fibers 22 can be applied to optical fibers 22 with the buffer 24 thereon.

Other modifications and alterations will occur to others upon their reading and understanding of the specification. It is intended that all such modifications and alterations be included insofar as they come within the scope of the invention as claimed or the equivalents thereof.

Having described the invention, the following is claimed:

1. A package for a fiber optic coupler having at least one optical fiber extending therefrom, said package comprised of:
a support substrate for supporting an optical coupler having at least one optical fiber extending therefrom, said optical fiber having an inner glass fiber cladding surrounded by an outer jacket;
a tube surrounding said substrate, said at least one optical fiber extending from one end of said tube;
a material enclosing each end of said tube, said material engaging said optical fiber where said optical fiber extends through said material; and
a metal layer covering at least a portion of each end of said tube, said optical fiber and said material, said metal layer sealing each end of said tube, said material and said optical fiber where said optical fiber extends through said material.

2. A package for a fiber optic coupler as defined in claim 1, further comprising an outer sleeve encasing said glass tube and sealing means for sealing the ends of said outer sleeve around said optical fiber.

3. A package for a fiber optic coupler as defined in claim 2, wherein said optical coupler is a 2×2 coupler.

4. A package for a fiber optic coupler as defined in claim 3, wherein said outer sleeve is formed of INVAR®.

5. A package for a fiber optic coupler as defined in claim 4, wherein said inner tube and said outer sleeve are cylindrical in shape.

6. A package for a fiber coupler as defined in claim 1, wherein said metal is deposited by arc spraying.

7. A package for a fiber optic coupler as defined in claim 6, wherein said metal is selected from the group consisting of aluminum zinc, copper, nickel, lead, tin/lead, tin/zinc, aluminum bronze, phosphor bronze, steel, stainless steel, monel and alloys thereof.

8. A package for a fiber optic coupler as defined in claim 1, wherein said metal is deposited by a vacuum metallization process.

9. A package for a fiber optic coupler as defined in claim 8, wherein said metal is deposited by sputtering.

10. A package for a fiber optic device or fiber optic component having at least one optical fiber extending therefrom, said package comprised of:
a support substrate for supporting said optical device or optic component having at least one optical fiber extending therefrom;
a tube surrounding said substrate, having an opening at each end, at least one optical fiber extending from one end of said tube through said opening; and
a layer of metal sealing the opening of each end of said tube and said optical fiber where said optical fiber extends through said layer of metal.

11. A package for a fiber optic device or fiber optic component as defined in claim 10, wherein said metal layer covers at least the outer end of said tube and the opening defined by said tube.

12. A package for a fiber optic device or fiber optic component as defined in claim 11, wherein said tube is a glass tube and said glass tube is contained within an outer metal tube.

13. A package for a fiber optic device or fiber optic component as defined in claim 10, wherein said metal layer covers at least the inner end of said tube and the opening defined by said tube.

14. A package for a fiber optic device or fiber optic component as defined in claim 13, wherein said tube is a metal tube.

15. A package for a fiber optic device or fiber optic component as defined in claim 10, further comprising a material enclosing each end of said tube, said material engaging said optical fiber where said optical fiber extends through said material.

16. A package for a fiber optic device or fiber optic component as defined in claim 15, wherein said layer of metal is deposited on said material.

17. A package for a fiber optic device or fiber optic component as defined in claim 15, wherein said optical fiber has an inner glass fiber cladding surrounded by an outer jacket, said material engaging said inner glass fiber cladding where said optical fiber extends through said material.

18. A package for a fiber optic device or fiber optic component as defined in claim 16, wherein said material engages said outer jacket where said optical fiber extends through said material.

19. A method of packaging a fiber optic device having at least one optical fiber extending therefrom, comprising the steps of:
a) mounting a fiber optic device having at least one optical fiber extending therefrom onto a substrate;
b) enclosing said fiber optic device within a cavity in a structure having at least one opening therein through which said at least one optical fiber extends; and
c) forming a generally continuous moisture impervious layer over said opening and said optical fiber, wherein said moisture impervious layer closes said opening in said structure and seals said cavity.

20. A method of packaging as defined in claimed 19, wherein said structure is a tube containing said substrate.

21. A method of packaging as defined in claim 20, wherein said tube is glass.

22. A method of packaging as defined in claim 21, wherein said moisture impervious layer is formed of metal.

23. A method of packaging as defined in claim 22, wherein said step of forming a generally continuous layer is comprised of arc spraying said structure.

24. A method of packaging as defined in claim 23, wherein said metal is selected from the group consisting of aluminum, zinc, lead, copper, nickel, lead, tin/lead, tin/zinc, aluminum bronze, phosphor bronze, steel, stainless steel, monel, gold and alloys thereof.

25. A method of packaging as defined in claim 24, wherein a barrier material is disposed in said opening and said metal, moisture impervious layer is applied thereto.

26. A method of packaging as defined in claim 25, wherein said optical device is a coupler.

27. A method of packaging as defined in claim 22, comprising the additional steps of:
d) positioning a protective metal outer tube around said glass tube; and
e) filling the ends of said protective metal tube with an adhesive/sealant material that surrounds said optical fiber.

28. A method of packaging as defined in claim 19, wherein said continuous moisture impervious layer is formed of a material selected from the group consisting of glass, ceramic and metal, and said material is applied to said structure by a thermal spraying process.

29. A method of packaging as defined in claim 28, wherein said structure is a plastic tube, and said material is a metal that is arc-sprayed to totally cover said plastic tube.

30. A packaged, optical device, comprised of:
an optical device having at least one optical fiber extending therefrom;
a structurally rigid housing encasing said optical device, said housing having an internal cavity for containing said optical device and at least one opening in said housing communicating with said cavity, said optical fiber extending through said opening; and
a continuous, arc sprayed barrier layer on said housing at least in the vicinity of said opening, said barrier layer covering said housing in the vicinity of said opening and a portion of the optical fiber extending through said opening and covering said opening to seal said optical device within said housing.

31. A packaged, optical device as defined in claim 30, wherein said barrier layer is metal.

32. A packaged, optical device as defined in claim 31, wherein said housing is a tube having an opening at each end thereof.

33. A packaged, optical device as defined in claim 32, wherein said tube is formed of a material selected from the group consisting of glass, quartz, plastic and metal.

34. A packaged, optical device as defined in claim 33, wherein said housing is plastic and said metal barrier layer entirely covers said housing.

35. A packaged, optical device as defined in claim 33, wherein said opening in said tube is plugged with an adhesive material and said barrier layer is arcsprayed onto the surface of said adhesive material to seal said opening.

36. A packaged, optical device as defined in claim 35, wherein said optical device is mounted to a support substrate within said tube.

37. A packaged, optical device as defined in claim 36, wherein said housing is disposed within an outer protective sleeve, said protective sleeve encasing said housing and having an adhesive/sealant plugging the ends of said protective sleeve, said optical fiber extending through said adhesive/sealant.

38. A packaged, optical device as defined in claim 30, wherein said optical fiber has an outer buffer surrounding an inner glass cladding and said barrier layer covers said outer buffer.

39. A packaged, optical device as defined in claim 30, wherein said optical fiber has an outer buffer surrounding an inner glass cladding, and said outer buffer on said optical fiber is removed where said optical fiber extends through said barrier layer and said barrier layer covers said inner glass cladding.
